(19) United States
(12) Patent Application Publication
(10) Pub. No.: US 2007/0053765 A1
(43) Pub. Date: Mar. 8, 2007

(54) Thread on a bone screw

(76) Inventors: David Russell Warnick, Spanish Fork, UT (US); David T. Hawkes, Pleasant Grove, UT (US)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 11/495,914

(22) Filed: Jul. 28, 2006

Related U.S. Application Data
(60) Provisional application No. 60/703,621, filed on Jul. 29, 2005.

(51) Int. Cl. F16B 33/00

(52) U.S. Cl. 411/378

(57) ABSTRACT

A screw, which may be used, for example, as a bone screw, includes a shaft bearing a thread, the thread having a thread foot and thread crest. The thread foot tapers outward along a portion of the shaft, and the thread crest has a uniform width along a length of the shaft. A method of making a bone screw includes making a series of cuts in a shaft at different pitches to produce a thread having a thread foot and thread crest, where the thread foot tapers outward along a portion of the shaft; and where the thread crest has a uniform width along a length of the shaft.

### RELATED APPLICATION

The present application claims priority under 35 U.S.C. §119(e) of previous U.S. Provisional Patent Application No. 60/703,621, filed Jul. 29, 2005, entitled “Method for Manufacturing Tapered Thread Roots and Transitioning to Straight Roots While Maintaining a Constant Thread Crest,” which application is incorporated herein by reference in its entirety.

### BACKGROUND

As the name implies, bone screws are typically used to anchor an implanted medical appliance to a patient's bones or related skeletal structure. For example, bone screws can be used to secure a plate or rod system to a patient's spine or related skeletal structure to treat conditions such as vertebrae instability. Such systems typically include a longitudinal support structure, such as a plate or rod, and anchoring elements, such as screws and hooks, for attaching the support structure to the vertebrae. If screws are used, the screws may be inserted through the patient's pedicle. A bone screw that is passed through the pedicle may also be referred to as a pedicle screw. Because bone screws are threaded into the bone, bone screws usually provide more stability than other anchoring elements, such as hooks.

Pedicle and bone screws experience different kinds of stress when used to secure a medical appliance to, for example, a patient's spine. These stresses can include a flexing stress which tends to flex or bend the screw and a traction stress which tends to pull the screw along its length and out of the bone in which it is anchored. The flexing stress can, in extreme cases, result in fatigue and even mechanical failure, i.e., cracking or breaking of the screw. Traction stress threatens the interface between the screw and the bone in which the screw is anchored, but typically does not threaten the integrity of the screw itself.

Regardless of the particular application, the design of a bone screw will help determine the ease with which the screw is placed as well as the durability of the screw. In terms of design, the screw is divided into two major portions. The stem or shaft portion bears the threading of the bone screw and engages and anchors in the bone. The head portion is typically wider than the shaft portion and engages the medical appliance that is secured by the screw.

The design of the shaft portion, particularly its threading, is a significant factor in determining both the long and short term viability of the screw. Short term stability, including the ease with which the screw is placed, is governed primarily by the mechanical design of the screw itself. The long term viability of the screw is determined by both its mechanical design and biological factors inherent in the environment in which it is used. The most important of these biological factors is the interface between the screw and the bone in which it is lodged. This interface is created, in large part, by the design of the threading on the screw, hence the importance of the thread design.

### SUMMARY

A screw, which may be used, for example, as a bone screw, includes a shaft bearing a thread, the thread having a thread foot and thread crest. The thread foot tapers outward along a portion of the shaft, and the thread crest has a uniform width along a length of the shaft. A method of making a bone screw includes making a series of cuts in a shaft at different pitches to produce a thread having a thread foot and thread crest, where the thread foot tapers outward along a portion of the shaft; and where the thread crest has a uniform width along a length of the shaft.

### BRIEF DESCRIPTION OF THE DRAWINGS

The accompanying drawings illustrate various embodiments of the present invention and are a part of the specification. The illustrated embodiments are merely examples of the present invention and do not limit the scope of the claims.

FIG. 1 illustrates the preparation of a thread on a shaft, such as a bone screw shaft.

FIG. 2 illustrates the preparation of a thread on a shaft, such as a bone screw, where the thread has a tapered thread foot and a thread crest with a width that varies with the tapering of the thread foot.

FIG. 3 illustrates the preparation of a thread on a shaft, such as a bone screw, where the thread has a tapered thread foot and a thread crest with a constant width. Additionally, the thread has a constant width from foot to crest.

FIG. 4 illustrates a first step in a method according to the principles described herein of preparing a thread on a shaft, such as a bone screw, where the thread has a tapered thread foot over a portion of the screw length and a thread crest with a constant width. Additionally, the thread is thickest at its foot and narrows to its crest.

FIG. 5 illustrates a detailed cross section of the cutter illustrated in FIG. 4.

FIG. 6 illustrates a second step in the method of FIG. 4 according to principles described herein.

FIG. 7 illustrates a third step in the method of FIG. 4 according to principles described herein. FIG. 7 further illustrates the resulting threaded shaft or bone screw, where the thread has a tapered thread foot over a portion of the screw length and a thread crest with a constant width. Additionally, the thread is thickest at its foot and narrows to its crest.

FIG. 8 is a flowchart further illustrating the method of FIGS. 4, 6 and 7, according to principles disclosed herein.

Throughout the drawings, identical reference numbers designate similar, but not necessarily identical, elements.

### DETAILED DESCRIPTION

The present specification describes a bone or pedicle screw with a thread root that transitions along the shaft of the screw from a straight to a tapered root while the width of the thread crest remains constant and the thread is thickest at its foot and narrows or tapers to its crest. A bone screw having this thread configuration is better able to secure implanted medical appliances to bones and skeletal structure including, but not limited to, the spine and vertebrae. The present specification will also describe a method of making this screw with both tapered and straight thread roots, constant thread crest and thread that narrows from foot to crest.

In the following description, for purposes of explanation, numerous specific details are set forth in order to provide a thorough understanding of the principles disclosed herein for the threading on a bone screw and methods for making the same. It will be apparent, however, to one skilled in the art that the described fasteners and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

As is commonly understood, screws and other fasteners typically comprise a thread or threading that mates with corresponding threads or with the material of a support structure. In this way, members of a system can be securely fastened together. As indicated above, bone or pedicle screws are particularly adapted to securing an implanted medical applicant to the bones or skeletal structure of a patient.

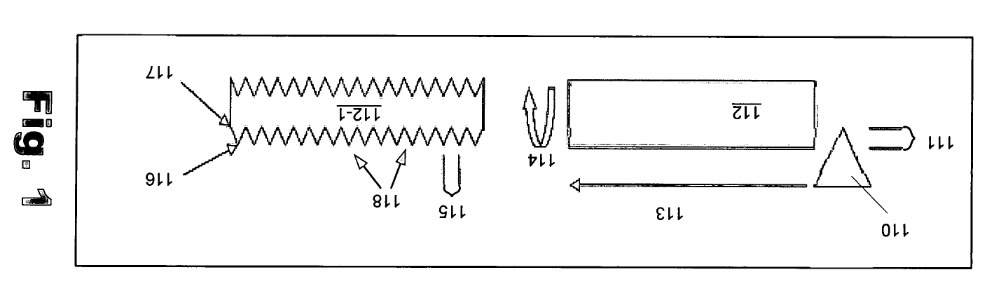

FIG. 1 is used to illustrate the basic means of forming a thread and to define the important terms used in describing a thread and its formation. As is illustrated in FIG. 1, a cutter (110) is used to cut the desired thread into a shaft (112). The shaft (112) may be a screw, other fastener or other threaded device, or a component that will eventually be formed into a screw, other fastener or other threaded member. In FIG. 1, the cutter (110) is represented by a triangular cross-section. However, it will be understood by those skilled in the art that the cutter (110) may take on a variety of shapes and configurations. Different cutter configurations will be described below.

The thread or threading is typically created by passing the cutter (110) axially back-and-forth across the shaft (112), e.g., in and out of the drawing in FIG. 1, while the shaft (112) is rotated as shown by arrow (114). In addition to the rotation (114), the shaft (112) is also moved longitudinally past the cutter (110) in the direction indicated by the arrow (113). Or, alternatively, the cutter (110) may move along the rotating, but stationary, shaft (112) in the direction indicated by the arrow (113). The result is a thread (118) cut into the now-threaded shaft (112-1). The geometry of the thread is that of a helical groove winding along the shaft (112-1), the groove constituting the desired thread.

The form of the resulting thread (118) is determined by the shape or cross section of the cutter (110) and is further defined by a number of parameters. For example, the “pitch” of the thread (118) is the distance (115) between thread crests (116) and is determined by the distance the cutter (110) moves along the axis of the shaft (112) per revolution (114).

The root of the thread (117) is the deepest part of the thread from the surface of the shaft (112) and is formed by the tip of the cutter (110) or that portion of the cutter (110) that cuts deepest into the shaft (112). The thread root (117) is also associated with what is called the minor diameter of the thread (118). Conversely, the thread crest (116) is associated with what is called the major diameter of the thread (118). The thread crest (116) is formed where the cutter (110) intersects the surface of the shaft (112). The depth of the cut is the distance (111) from the thread root to the thread crest and is determined by the depth the cutter (110) cuts in to the shaft (112).

The prior art teaches three basic thread designs for bone screws: (1) screws with cylindrical threads, (2) screws with full conical threads and (3) screws with partly conical threads. Each of these thread types will be described briefly below.

For a screw with cylindrical threads, both the shaft and the threads of the screw on the shaft are circular and cylindrical, meaning, in some exmamples, that the thread is uniform in all respects along the length of the shaft, with the possible exception of the screw tip. This type of screw offers the highest resistance to extraction by traction stress. Moreover, when the screw is removed or backed out over a small percentage of its length, the subsequent resistance to extraction by traction stress is not significantly affected. However, the cylindrically-treaded screw may exhibit poor interface with the bone in which it is anchored unless a pilot hole is carefully drilled prior to inserting the screw. Additionally, undesired widening of the entry site or cracking may be caused by the insertion of the screw.

On screws with fully conical threads both the body of the shaft and the thread are conical. This type of screw grips very tightly the material into which it is anchored. However, the fully conical screw also tends to have a sharp end that present problems, particularly in medical applications where relatively soft tissue may be inadvertently cut or damaged as the screw is positioned for use. Additionally, if a fully conical screw is partially removed or unscrewed and then retightened, it does not retain the same grip on the bone as when originally inserted, thereby increasing a tendency to loosen over time.

On screws with partly conical threads, the screw shaft has a conical shape that is surrounded by a thread that is cylindrical. Consequently, the depth of the cut or the height of the thread crest relative to the shaft body will increase along the length of the screw. A partly conical screw is highly resistant to extraction by traction stress due to the configuration of the cylindrical thread. However, like the fully conical screw, if the partly conical threaded screw is partially removed or unscrewed and then retightened, it does not retain the same grip on the bone as when originally inserted, thereby increasing a tendency to loosen over time. Additionally, the upper portion of the shaft is relatively wide, which can result in bone fissures.

Referring again to FIG. 1, as will be appreciated by those skilled in the art, the thread design can be varied by altering or adjusting the variables identified above. For example, the shape of the thread can be selected by changing the shape or cross section of the cutter (110). The depth of the cut can be changed by controlling how deeply the cutter (110) is forced into the material of the shaft (112). The pitch of the thread can be adjusted by controlling how quickly the shaft or cutter is moved longitudinally (arrow 113) relative to the speed of the rotation (arrow 114) of the shaft (112).

Ideally, the threading on a bone screw should be designed to provide for a good grip when inserted into the bone, while resisting or being unaffected by flexing and traction stresses. Any such design improvements are very desirable to improve screw reliability and provide consequent benefits to the patients in whom such screws are used. To this end, the present application describes a bone or pedicle screw with a thread root that transitions along the shaft of the screw from a straight to a tapered root while the width of the thread crest remains constant and the thread is thickest at its foot and narrows or tapers to its crest.

As will be appreciated from the foregoing discussion of FIG. 1, the depth of the cutter (110) can be changed along the length of the screw to vary the depth of the thread root (117). In some designs, the depth of the thread root tapers such that the tread root is deepest near the tip of the screw and most shallow near the head of the screw. In other designs, the thread root may be at a constant depth over a portion of the shaft and then taper from deep to shallow over the remainder of the shaft.

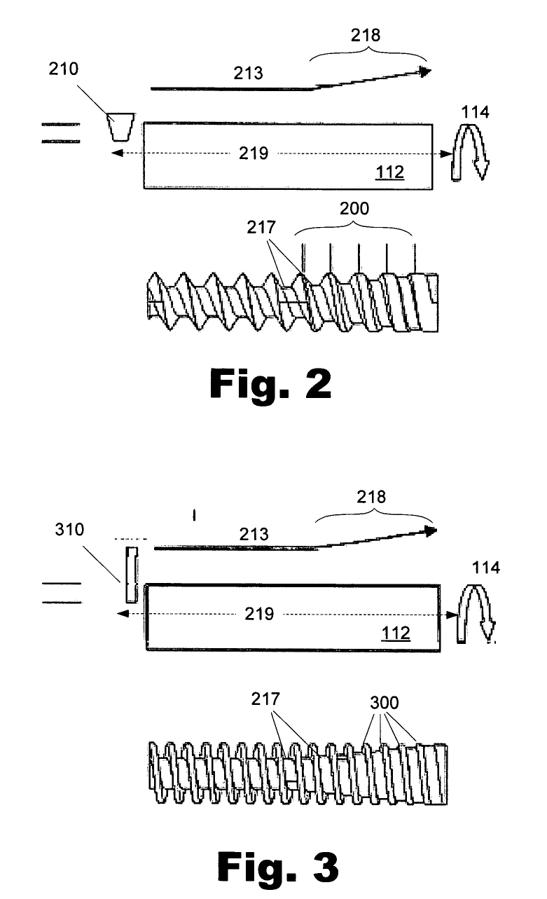

FIG. 2 illustrates a cutter (210). As shown in FIG. 2, the cutter (210) moves relative to the shaft (112), as indicated by arrow (213). The right portion of arrow (213), identified in the drawing as (218), angles upward to indicate that, over this portion of the shaft (112), the cutter (210) is moved gradually upward such that it cuts less deeply into the shaft (112) with each rotation (114) of the shaft (112). The result, as shown in the lower portion of FIG. 2, is that the depth of the thread root (217) is constant on the left side of the shaft (112) where the location of the cutter (210) relative to the central axis (219) of the shaft (112) is also constant. However, on the right side of the shaft (112), where the cutter (210) is being moved away from the central axis (219) of the shaft (112), the thread root (217) becomes gradually less deep, tapering upward toward the right end of the shaft (212). As noted above, this is referred to as a tapered root.

Changing the depth of the cut made by the cutter (210) can create threads with a root that tapers over the entire length of the shaft, threads that transition from a straight to a tapered root, or any combination of these. If the pitch is greater than the widest portion of the cut, the shaft's outside diameter will be the major diameter of the thread. If the shaft has a constant major diameter, the threads will also have a constant major diameter.

The cutter (210) shown in FIG. 2 has sides that are angled with respect to vertical or with respect to lines normal to the central axis (219) of the shaft (112). As a result, the width of the thread crests (200) will vary over the same portion of the shaft (218) that the thread root (217) tapers outward. The cutter (210) is illustrated and described in further detail below in connection with FIG. 5.

In contrast, as illustrated in FIG. 3, if the cutter (310) instead has sides that are straight, e.g., parallel or normal to the central axis (219) of the shaft (112), the width of the thread crests (300) will remain constant along the length of the shaft (112). Additionally, the tread will have a constant width from root to crest as shown in FIG. 3.

Thus, as noted above, by varying the movement and shape of the cutter, a variety of different thread designs can be created.

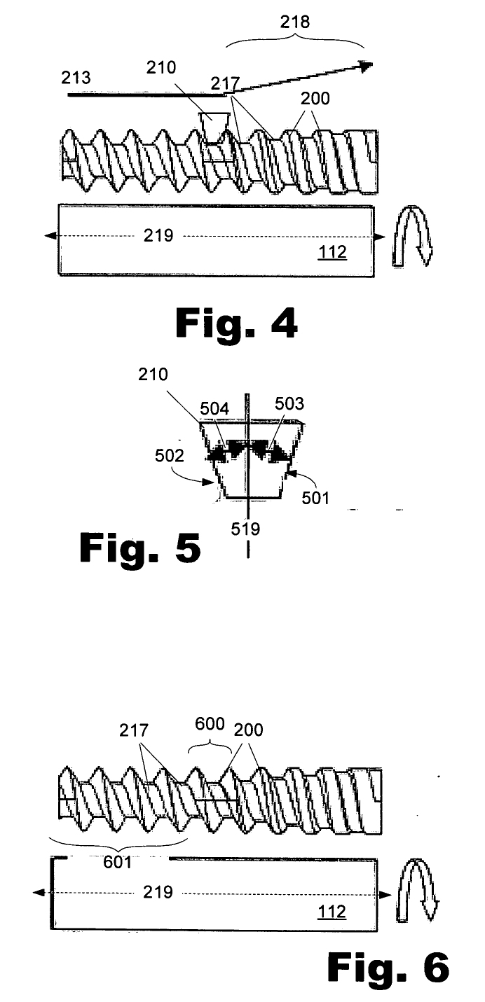

With reference to FIGS. 4-7, a process of forming a bone screw will be described using a series of cuts to produce a desired configuration of thread roots and thread crests. The resulting bone screw will have a thread root that transitions along the shaft of the screw from a straight to a tapered root while the width of the thread crest remains constant and the thread is thickest at its foot and narrows or tapers to its crest.

The first of this series of cuts is illustrated in FIG. 4. As shown in FIG. 4, a cutter (210) with angled or tapered sides, as described above, is used to cut an initial thread. FIG. 5 provides a detailed view of the cutter (210) including the leading (501) and trailing (502) edges which are disposed at a leading (503) and trailing (504) angles relative to a vertical axis (519) that is normal to the central axis (219) of the shaft to be cut.

The cutter (210) moves relative to the shaft (112) as shown by arrow (213), including a gradual withdrawal (218) away from the central axis (219) of the shaft toward the right of the figure. As noted above, the relative movement between the cutter (210) and the shaft (112) can be produced by moving either the cutter (210) and/or the shaft (112). If the shaft (112) is moved, it is moved in the opposite direction as indicated by arrow (213).

The result is a thread root (217) that is constant over the left portion of the shaft (112) and then transitions into a tapered portion (218). The tapered potion (218) tapers outward from the central axis (219) toward the right of the shaft (112). Typically, the head of the bone screw would be to the right end of the shaft (112) as illustrated in FIG. 4.

As the cutter beings to taper out of the shaft (112) during this first cut, each successive thread crest (200) increases in width as shown in FIG. 4. This change in crest width results from the angled cutter (210) disengaging from the shaft (112). The further the angled cutter (210) moves away from the central axis (219), the wider the resulting thread crests will be. In other words, the thread crest that is cut a full revolution before the root begins to taper will increase in width less than successive thread crests along the tapered root (as a function of the tangent of the trailing angle (504) only).

This happens because, at the point the root (217) begins to taper, the leading edge (501) of the cutter (210) is cutting the thread crest in front of the cutter (210) while the trailing edge (502) of the cutter is cutting the thread crest behind the cutter (210). The thread crest remains the same width and shape as the leading edge (501) creates the leading side of the thread crest when the cutter is maintaining a straight root but increases in width as the trailing edge (502) of the cutter begins disengaging from the shaft following the taper and forming the trailing side of the crest. This full revolution of the crest is wider than the previous crests by the tangent of the angle of the trailing edge (502) multiplied by the change in the depth of cut per revolution.

Referring to FIG. 6, we focus on the portion (600) of the shaft (112) where the thread foot (217) transitions from constant or straight to an upward taper (represented by portion (218) in FIG. 4). After the first revolution before the taper, each successive thread crest increases in size as a function of the tangent of the angle of the leading (501) and the trailing edge (502) of the cutter. Now as the cutter (210) moves along the shaft, the thread crest width is increased as both the leading and trailing edge (502) move out of the shaft.

The object, however, is to make the thread crest (200) of constant width in this portion (600) of the shaft (112) where the thread foot transitions from a straight to a tapered configuration. As noted above, the width of the thread crest (200) begins to vary as soon as the thread foot (217) begins to taper.

To make this portion (600) of the thread crest (200) have a constant width, i.e., the same width as the previous thread crests, a second cutting pass with the cutter (210) is made over only this one revolution of the shaft (112), where the transition to a tapered tread foot occurs. The cutter (210) starts out one revolution back from where the root (217) starts to taper, aligned with where the previous thread was cut. This time the cutter (210) moves through this one revolution at a greater pitch. The pitch is increased by the amount the current crest is wider than the previous crest. When this cut is done, this portion (600) of the thread has the same thread crest width as the thread on the first part (601) of the shaft (112), as shown in FIG. 6.

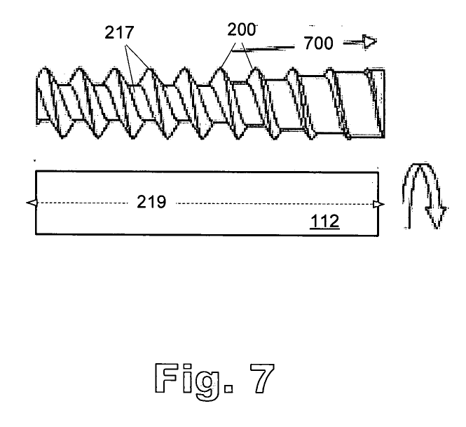

Turning now to FIG. 7, to finish creating a constant thread crest width along the entire shaft (112), a third cut is made at a larger pitch and a shallower taper angle (700). The pitch is increased by the amount each successive thread crest is longer than the previous crest (or the tangent of the trailing angle (504) and the tangent of the leading angle (503) added and both multiplied by the amount the first depth of cut decreased per revolution). This cuts the wider thread crests down to the same width as the previous thread crests. Also, the taper angle is decreased so that the root at any location along the taper will stay at the same diameter as the roots form the previous cuts even though the pitch is increased.

The result is a thread, as shown in FIG. 7, in which the thread crest width is constant along the entire length of the shaft (112), the thread root (217) is constant over a left portion of the shaft (112) and then tapers outward toward the right portion of the shaft (112). Additionally, the thread is widest at its base, at the thread root, and tapers inward or narrows toward the thread crest (200). This thread design, when incorporated into a fastener such as a bone screw, increases the strength and longevity of the screw, while also providing a screw that attaches easily and well and yet resists applied stresses.

The following equations detail each of the three cuts described above that are used in forming the described thread.

First Cut:
Starting point=end of shaft
Pitch
Taper angle
Decrease in depth of cut per revolution=tangent (Taper angle)×Pitch
Trailing angle
Leading angle

Second Cut:
Pitch 2=Pitch+tangent (Trailing angle)×Decrease in depth of cut per revolution
Starting point second cut=Starting point tapered root−Pitch (at root diameter)
Ending point second cut=Starting point tapered root−Pitch+Pitch 2 (at root diameter+Decrease in depth of cut per revolution)

Third Cut
Pitch 3=Pitch 2+tangent (Leading angle)×Decrease in depth of cut per revolution
Starting point third cut=Ending point second cut
Taper angle third cut=tangent (Decrease in depth of cut per revolution/Pitch 3)

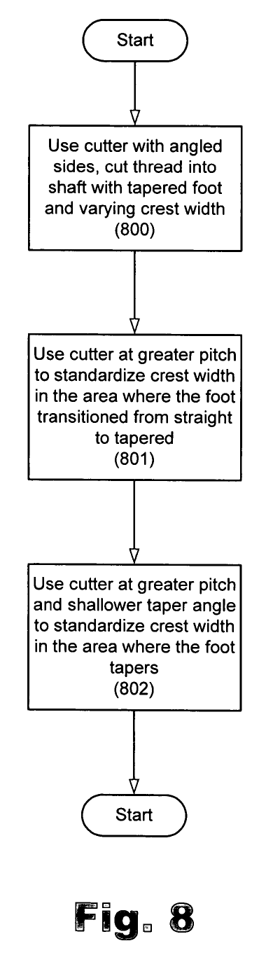

FIG. 8 is a flowchart that summarizes the three principal steps of the method described herein for forming a tread on, for example, a bone screw, in which the thread crest width is constant along the entire length of the shaft, the thread root is constant over a portion of the shaft and then tapers outward over another portion of the shaft. Additionally, the thread is widest at its base, at the thread root, and tapers inward or narrows toward the thread crest (200).

As shown in FIG. 8, a cutter is first used, the cutter having angled sides. The cutter makes a first cut that produces a thread in the shaft with a foot that has a tapered portion and thread crests of varying width. (Step 800).

Next, a second cut is made with the cutter over the rotation of the shaft where the foot transitions from straight to tapered. This cute is made at a great pitch (step 801) and renders width of the thread crest of the transitional portion equal to or standardized with the width of the thread crest over that portion of the shaft were the thread foot is not tapered.

Lastly, a third cut is made with the cutter at greater pitch and shallower taper angle over that potion of the shaft where the thread foot is tapered. This renders the width of the thread crest over this portion of the shaft equal to or standardized with the width of the thread crest over that portion of the shaft were the thread foot is not tapered.

The preceding description has been presented only to illustrate and describe embodiments of the principles disclosed. It is not intended to be exhaustive or to limit these principles to any precise form disclosed. Many modifications and variations are possible in light of the above teaching.

What is claimed is:

1. A screw comprising:
a shaft bearing a thread, said thread having a thread foot and thread crest;
wherein said thread foot tapers outward along a portion of said shaft; and
wherein said thread crest has a uniform width along a length of said shaft.

2. The screw of claim 1, wherein said thread is thickest at said thread foot and narrows toward said thread crest.

3. The screw of claim 1, wherein said thread foot is constant over a first portion of said shaft and tapers outward over a second portion of said shaft.

4. A method of making a bone screw, said method comprising making a series of cuts in a shaft at different pitches to produce a thread having a thread foot and thread crest, wherein said thread foot tapers outward along a portion of said shaft; and wherein said thread crest has a uniform width along a length of said shaft.

5. The method of claim 4, wherein said thread is thickest at said thread foot and narrows toward said thread crest.

6. The method of claim 4, wherein said thread foot is constant over a first portion of said shaft and tapers outward over a second portion of said shaft.

7. The method of claim 4, wherein said series of cuts is performed with a cutter having angled sides.

8. The method of claim 4, wherein a first cut of said series of cuts is made including a taper angle for said thread foot.

9. The method of claim 8, wherein a second cut of said series of cuts is made in an area where said thread foot transitions from straight to tapered.

10. The method of claim 9, wherein said second cut is made at a greater pitch that a first of said series of cuts.

11. The method of claim 10, wherein a third cut of said series of cuts is made at a greater pitch that said second cut and at a shallower taper angle said first cut over a portion of said shaft over which said thread foot tapers.

12. A screw comprising:
a screw body having a first portion and a second portion;
a first set of screw threads positioned on the first portion;
a second set of screw threads positioned on the second portion, each of the first set and the second set of screw threads having a major diameter, wherein successive, adjacent major diameter portions of the first set of screw threads are spaced apart by a first pitch distance and successive, adjacent major diameter portions of the second set of screw threads are spaced apart by a second pitch distance that is greater than the first pitch distance.

13. The screw of claim 12, wherein the second pitch distance increases along the second portion as an inner diameter of the second portion increases.

14. The screw of claim 13, wherein the second pitch distance increases per revolution around the screw body.

15. The screw of claim 12, wherein the major diameter of the first set and the second set of screw threads is constant over the screw body.

16. The screw of claim 12, further comprising:
a screw head positioned proximal the second portion of the screw body.

17. The screw of claim 15, wherein a minor diameter of each of the second set of screw threads increases successively in a direction toward the screw head.

18. A method for forming screw threads in an shaft, the method comprising:
moving a cutter by a first pitch distance per revolution axially across a first portion and a second portion of the shaft to form a plurality of successive screw threads having major diameter portions spaced apart by the first pitch distance;
decreasing a cutting depth of the cutter over the second portion of the shaft;
placing the cutter on the shaft proximate the second portion; and
moving the cutter over at least a section of the second portion of the shaft at a second pitch distance that is greater than the first pitch distance.

19. The method of claim 18, wherein moving the cutter includes moving the cutter relative to the shaft.

20. The method of claim 18, wherein placing the cutter on the shaft includes placing the cutter placed one revolution back from the second portion of the shaft.

21. The method of claim 18, wherein decreasing the cutting depth of the cutter includes decreasing a depth of cut per revolution.

22. The method of claim 18, wherein decreasing the cutting depth of the cutter includes tapering the cutter out of the shaft over the second portion.

23. The method of claim 18, wherein moving the cutter over at least the section of the second portion of the shaft at the second pitch distance includes moving the cutter for at least one revolution.

24. The method of claim 18, further comprising:
increasing the second pitch distance as the cutter moves along the second portion of the shaft.
